(19) United States
(12) Patent Application Publication
(10) Pub. No.: US 2015/0199105 A1
(43) Pub. Date: Jul. 16, 2015

(54) AUTOMATIC SELECTION OF CENTER OF ROTATION FOR GRAPHICAL SCENES

(71) Applicant: Silicon Graphics International, Corp., Milpitas, CA (US)

(72) Inventor: Marc Hansen, Morgan Hill, CA (US)

(73) Assignee: Silicon Graphics International, Corp., Milpitas, CA (US)

(21) Appl. No.: 14/152,968

(22) Filed: Jan. 10, 2014

(51) Int. Cl. G06F 3/0481; G06F 3/0484

(52) U.S. Cl. CPC G06F 3/04815; G06F 3/04845

(57) ABSTRACT

A center of rotation may automatically be selected for graphically displayed data. The rotation center may be automatically selected based on what is determined to be of interest to the user, the current display of the data, and other parameters. For example, if a user has selected a portion of data, the center of rotation may be within the center of the selected data. If a user has positioned a cursor within a portion of displayed data, the center of rotation may be the center of the data portion including the cursor. If the data as a whole is approximately centered about the graphical coordinate origin, or within a threshold of the origin, the data may be rotated about the origin. If the data as a whole is approximately centered at least a certain distance away from the graphical coordinate origin, the data may be rotated about the center of the data as a whole.

### BACKGROUND

1. Field of the Invention

The present invention relates to visualization of data. In particular, the present invention relates to rotating data about different useful points.

2. Description of the Prior Art

Visualization of data in three dimensional graphs can be helpful to understand the data. An example of a three dimensional graph is a plot of data on multiple axis, such as a horizontal, vertical, and another coming towards or away from the point of view of a viewer. Typically, visualization applications which display three dimensional data provide an interface having a graphical portion which provides data graphics and a control portion, such as a bar of control buttons. The control buttons may be implemented on a separate page from the graphical portion or otherwise separated from the graphical portion.

Many users desire to view their data from different angles in order to better understand data being visualized. However, it can be cumbersome to select a particular center of rotation. Moreover, an available center of rotation is often fixed. What is needed is an improved visualization interface for displaying data as desired by a user.

### SUMMARY

The present technology may automatically select a center of rotation for graphically displayed data. The rotation center may be automatically selected based on what is determined to be of interest to the user, the current display of the data, and other parameters. For example, if a user has selected a portion of data, the center of rotation may be within the center of the selected data. If a user has positioned a cursor within a portion of displayed data, the center of rotation may be the center of the data portion including the cursor. If the data as a whole is approximately centered about the graphical coordinate origin, or within a threshold of the origin, the data may be rotated about the origin. If the data as a whole is approximately centered at least a certain distance away from the graphical coordinate origin, the data may be rotated about the center of the data as a whole.

An embodiment may include a method which provides an image of a multi-dimensional (two, three or more dimensions) data within a graphical portion of an interface. A center of rotation may be automatically determined for the multi-dimensional data. Input may be received to rotate the data about the center of rotation. The data may be displayed as rotated about the automatically determined center of rotation.

An embodiment may include a system for displaying data. The system may include a processor, a memory, and one or more modules stored in memory. The one or more modules may be executed by the processor to provide an image of multi-dimensional data within a graphical portion of an interface, automatically determine a center of rotation for the multi-dimensional data, receive input to rotate the data about the center of rotation, and display the data rotated about the automatically determined center of rotation.

### BRIEF DESCRIPTION OF THE DRAWINGS

FIG. 1 is a system for processing and visualizing data.

FIG. 2 is a method for processing and visualizing data.

FIG. 3 is a method for rotating data.

FIG. 4 is a method for automatically selecting a center of rotation for displayed data.

FIG. 5 is a visualization interface having a graphical data.

FIG. 6A is a visualization interface having selected graphical data.

FIG. 6B is a visualization interface having rotated graphical data.

FIG. 7A is a visualization interface having a cursor within a data cluster.

FIG. 7B is a visualization interface having rotated graphical data.

FIG. 8A is a visualization interface having graphical data centered away from a coordinate origin.

FIG. 8B is a visualization interface having rotated graphical data.

FIG. 9A is a visualization interface having graphical data centered near a coordinate origin.

FIG. 9B is a visualization interface having rotated graphical data.

FIG. 10 provides a computing device for implementing the present technology.

### DETAILED DESCRIPTION

The present technology may automatically select a center of rotation for graphically displayed data. The rotation center may be automatically determined based on what is determined to be of interest to the user, the current display of the data, and other parameters. In some embodiments, if a user has selected a portion of data, the center of rotation may be determined to be at the center of the selected data. In some embodiments, when a cursor is positioned within a portion of displayed data, the center of rotation may be the center of a data cluster that includes the cursor. If the data as a whole is approximately centered about the graphical coordinate origin, or within a threshold of the origin, the data may be rotated about the origin. If the data as a whole is approximately centered at least a certain distance away from the graphical coordinate origin, the data may be rotated about the center of the data as a whole.

Though two or three dimensional data may be discussed herein, any multi-dimensional data may be used with the present technology.

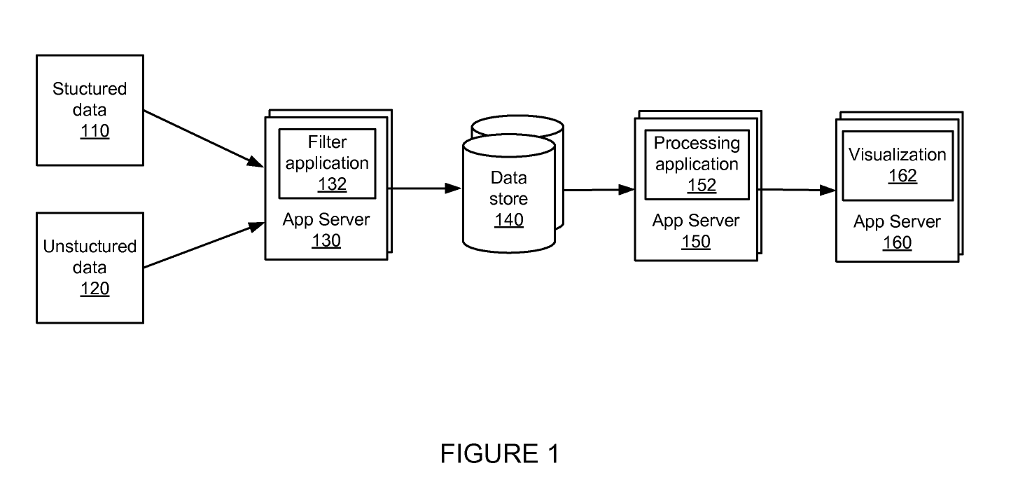

FIG. 1 is a system for processing and visualizing data. The system of FIG. 1 includes structured data 110, unstructured data 120, application servers 130, 150 and 160, and data store 140.

Structured data 110 (RDMS data) may include data items stored in tables. The structured data may be stored in a relational database, and may be formally described and organized according to a relational model. Structured data 110 may be data which can be managed using a relational database management system and may be accessed by application server 130.

Unstructured data may include data that does not include a predefined data model or does not fit into relational tables as structured data 110. Unstructured data may include text, dates, numbers, facts and other data, including email, media and documents. Unstructured data may also include lists or other data associated with web page clicks, shopping cart data, and other data. Unstructured data may be accessed by application server 130.

Application server may include one or more servers which receive and access structured data 110 and unstructured data 120. Filter application 132 may be stored and executed on application server 130, and may be executed to ingest the structured and unstructured data. Filter application 132 may apply filters, intelligence, or other processes to select a subset of the data received and/or accessed.

Data store 140 may include one or more data stores which receive data which has been filtered by filter application 132. Data stores 140 may include SQL servers, NoSQL servers, and other servers. The data may be stored in these servers until they are accessed for processing.

Application server 150 may include one or more servers which receive and/or access data stored in data store 140. Processing application 152 may be stored on application server 150. When executed, processing application 152 may access filtered data from data store 140 and analyze the data for trends, patterns, a particular data of interest, or other data desired for reporting. For example, processing application 152 may be implemented by “Apache Hadoop” software, which is an open source software application which provides a distributed application for analyzing data.

Once data is analyzed, visualization program 162 located on application server 160 may report the data to a user. The data may be provided in many forms, such as reports, visualizations, and other formats. For example, visualization application 162 may provide data in a three dimensional graphical visualization format. In some embodiments, processing application 152 and visualization module 162 may be implemented as part of a client server tool set for extracting data, mining data with analytical algorithms, and providing interactive visualization input.

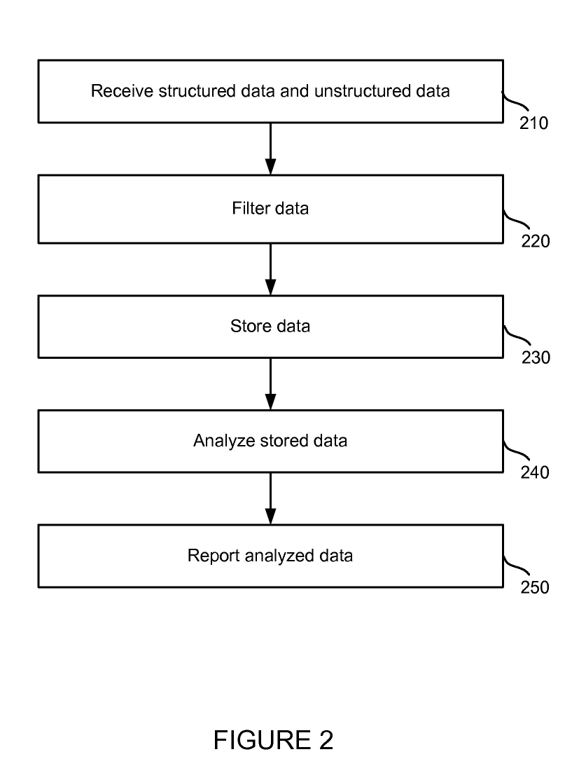

FIG. 2 is a method for analyzing and reporting data. The method of FIG. 2 may be performed by the system of FIG. 1. First, structured data and unstructured data may be received at step 210. The data may be received by filter application 132 on application server 130. The received data may be filtered at step 220. Filter application 132 may filter the data by time sampling, applying intelligence, and other methods to result in a subset of the entire set of the received data.

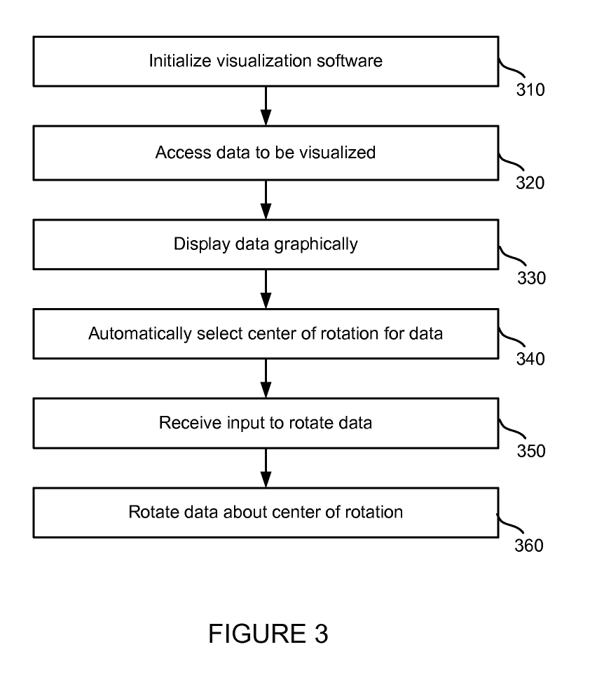

Filtered data may be stored at step 230. The data may be stored based on the type of data it is. For example, structured data may be stored in a SQL database and unstructured data may be stored in a NoSQL database. The stored data may be analyzed at step 240. Analyzing the data may include looking for trends, patterns, or otherwise processing the stored data to determine a subset of data to report to a user. Analyzing the data may be performed by processing application 152 on application server 150. Once the stored data is analyzed, the data can be reported at step 250. The data may be reported through an interactive visualization, reports, or other methods that may be useful to a user. The visualization may present a three dimensional graph of data and allow a user to manipulate the location of data about a center of rotation. The center of rotation for the data may be automatically determined. Step 250 is discussed in more detail with respect to FIG. 3.

FIG. 3 is a method for providing a visualization of data. The method of FIG. 3 may provide more detail for step 250 of the method of FIG. 2. In embodiments, visualization application 162 may perform the steps of FIG. 3. The visualization application 162 may extract stored data, mine data for desired information, and provide an interactive visualization of the data.

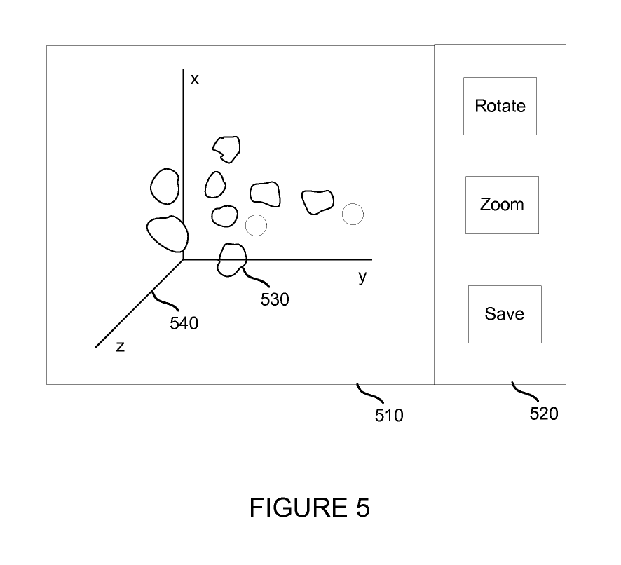

First, visualization software is initialized at step 310. Initializing the data may include executing the software, identifying what data to retrieve, and other configurations of the software. Data to be visualized may be accessed at step 320. The data may be accessed locally or remotely, for example from data store 140. The accessed data is graphically displayed through a display device at step 330. The data may be displayed in a three dimensional coordinate systems such as an x, y, and z coordinate system. An example of data graphically displayed in a three dimensional coordinate system is illustrated in FIG. 5.

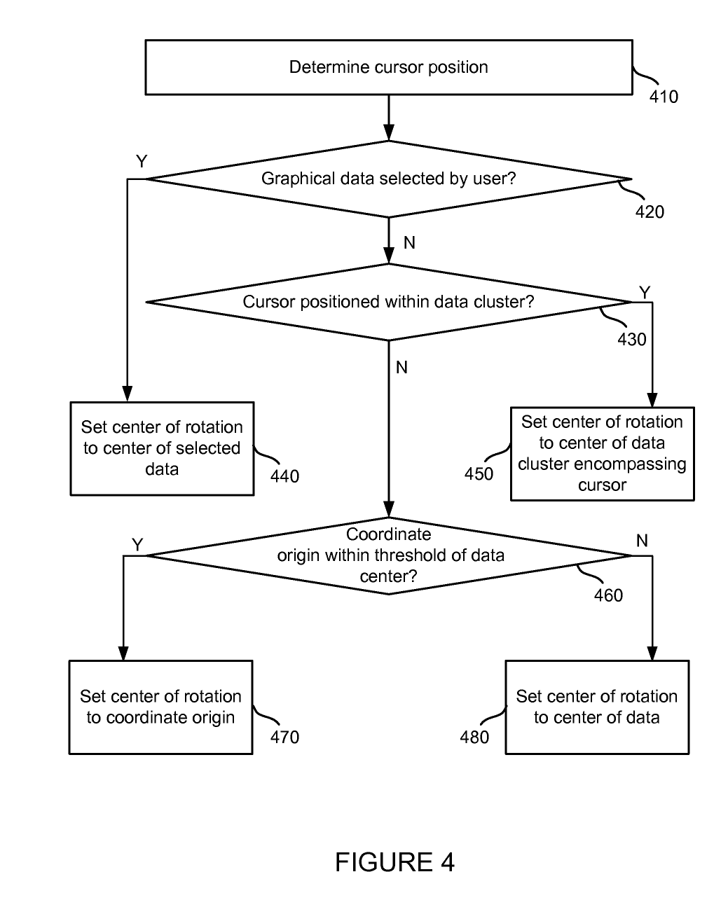

A center of rotation may be automatically selected for the data at step 340. The center of rotation may be automatically selected based on what is determined to be of interest to the user, the current display of the data, and other parameters. For example, the center of rotation may be automatically selected based on user selection of any portion of displayed data, a location of a cursor manipulated by a user, the position of the data, and other parameters. The center of rotation may also be set based on a default setting, for example based on a predetermined position previously indicated by a user, a position indicated by a collaborating user, a position where a majority of data is located, a position where the least amount of data is located, and other locations. In some instances, a collaborating user may include another user working on or accessing the same visualization at the same or different site. Automatically selecting a center of rotation for data is described in more detail with respect to the method of FIG. 4.

Input may be received to rotate data at step 350. The input may be received at any time, after one or more iterations of step 340. For example, the center of rotation for displayed data may initially be set at a center of all the displayed data. After a user selects a particular portion of data, the center of rotation may then automatically be set to the center of the selected data. The center of rotation for displayed data may change multiple times before input to rotate data is received.

Data may be rotated about the data center of rotation at step 360. The data may be rotated as much or little as desired by a user, as indicated by input received by a user. For example, the user may provide input by swiping a cursor across the automatically selected center of rotation to determine how far to rotate the data about the axis.

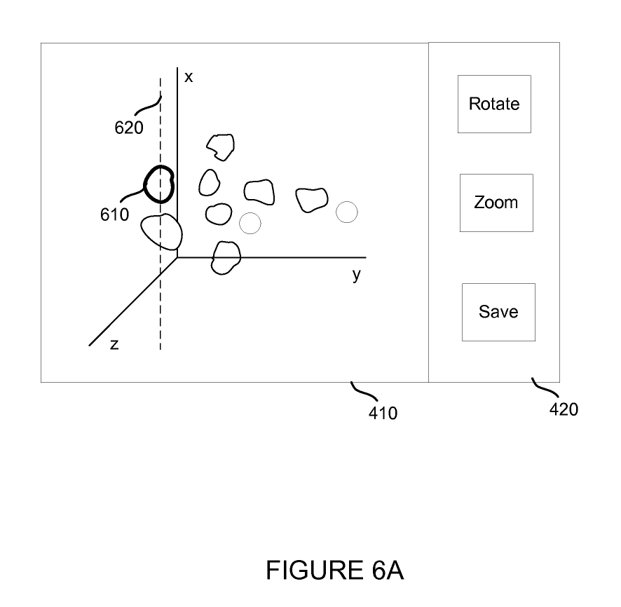

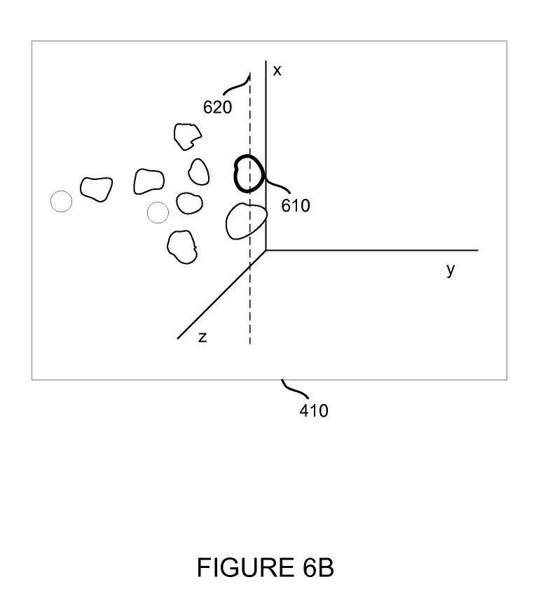

FIG. 4 is a method for automatically selecting a center of rotation for displayed data. The method of FIG. 4 provides more detail for step 340 of the method of FIG. 3. The steps of the method of FIG. 4 may be determined in any order, if at all, and should not be construed as required to be performed in any particular order, or to be performed at all. A cursor position is determined at step 410. A determination is then made as to whether graphical data is selected by the user at step 420. If no data is currently selected, the method continues to step 430. If data is selected, then the center of rotation is set to the center of the selected data at step 440. FIGS. 6A-6B illustrate rotation of data about a center of selected data.

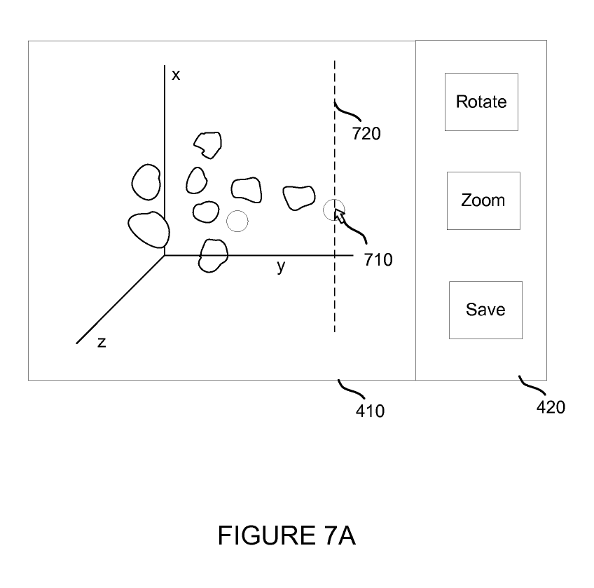

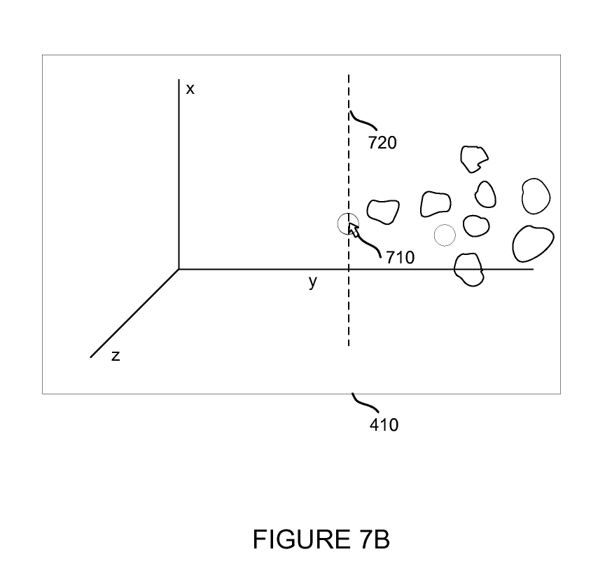

A determination is made as to whether a cursor is positioned within a data cluster at step 430. A data cluster may be any collection of one or more data points within a threshold distance of each other. If the cursor is not positioned within a data cluster, the method continues to step 460. If the cursor is positioned within a data cluster, the center of rotation for the displayed data is automatically set to the center of the data cluster which encompasses the cursor. FIGS. 7A-7B illustrate rotation of data about a center of selected data.

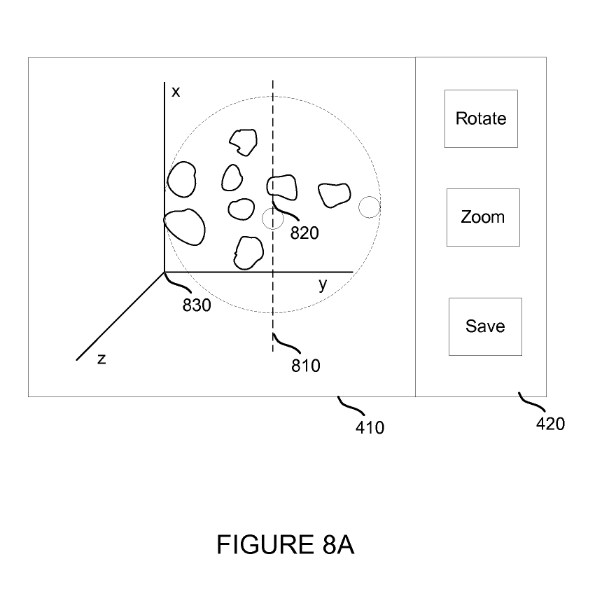

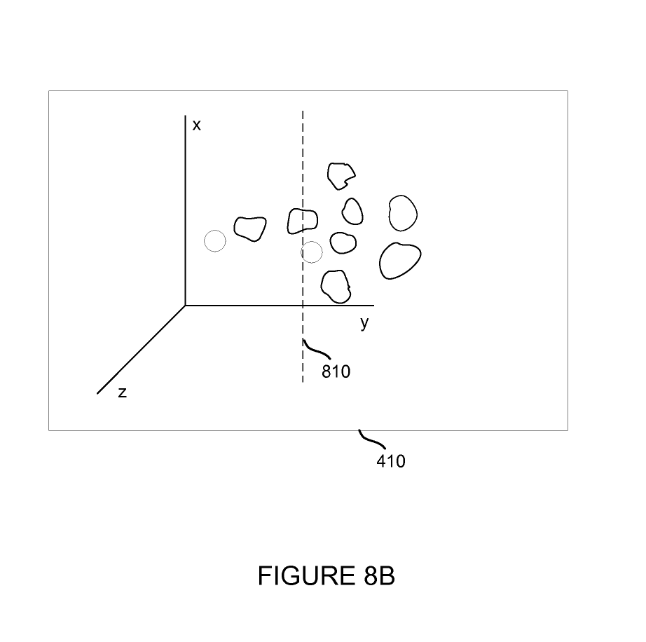

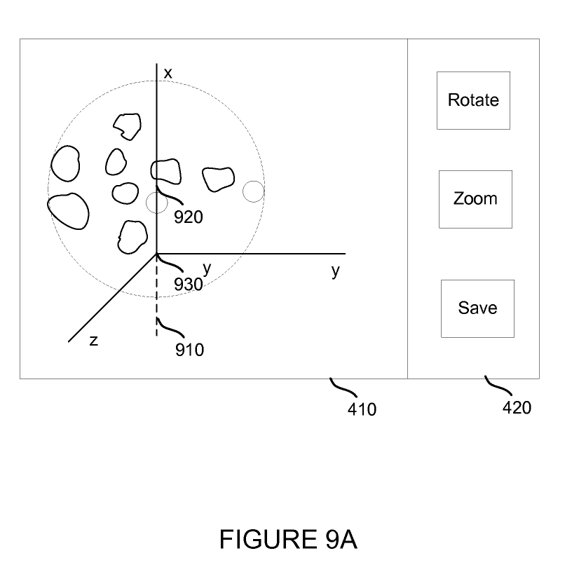

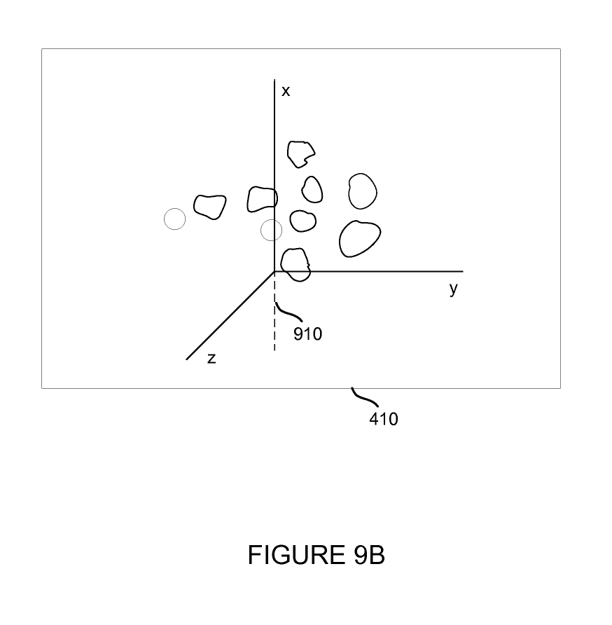

A determination is made as to whether the origin of the coordinate system is within a threshold of the data center at step 460. The data center may be determined by generating the smallest possible virtual globe around all displayed data points and determining the center of the globe as the center of the data. If the center of the data is not within a threshold of the coordinate system origin, such as for example, within twenty percent of the radius of the globe, the center of rotation is set as the center of the data (e.g., the center of the globe) at step 480. FIGS. 8A-8B illustrate rotation of data about a center of selected data. If the center of the data is within a threshold of the coordinate system origin, the center of rotation is set as the coordinate system origin at step 470. FIGS. 9A-9B illustrate rotation of data about a center of selected data.

Other methods may be used to automatically determine the center of rotation in addition to those discussed with respect to FIG. 4. For example, the center of rotation may automatically be set to the center of a display window. In this case, the depth of the center of rotation may be the average or median depth for the data currently displayed in the window.

FIGS. 5-9B illustrate examples of a visualization interface for displaying three dimensional data. FIG. 5 is a visualization interface containing graphical data. The interface of FIG. 5 includes a graphics portion 510 and a control portion 520. The control portion 520 includes buttons for performing functions, such as for example a rotate button, zoom button and save button. In some embodiments, control portion may be implemented on a separate interface page than graphics portion 510. Graphics portion 510 includes a graphical coordinate system, such as x, y, z axes 540, and data elements including data cluster 530. Data elements may include data clusters, data points, and other displayed data. In the interface of FIG. 5, the control of data manipulation within the graphics portion is managed by an interface within the control portion and separate from the graphics portion.

FIG. 6A is a visualization interface having selected graphical data. The interface of FIG. 6A illustrates data element 610 as being selected by a user. This is indicated with a thicker line forming the edge of data element 610. Because data element 610 has been selected by a user, the center of rotation may be axis 620, which is generated in the center of selected data element 610. In some instances, the center of rotation 620 may be generated as a horizontal axis. In some instances, the center of rotation 620 may be generated as horizontal vertical, horizontal, or arbitrary axis specified by user input (e.g., an axis perpendicular to the cursor movement). FIG. 6B is a visualization interface having rotated graphical data. As shown, the data of FIG. 6A is rotated about axis 620 which was generated to be centered at selected data element 610.

FIG. 7A is a visualization interface having a cursor within a data cluster. The interface of FIG. 7A illustrates data element 710 as encompassing a cursor manipulated by a user. Because data element 710 encompasses the cursor, the center of rotation may be axis 720, which is generated in the center of selected data element 710. The center of rotation 720 may be generated as a horizontal axis, vertical axis, or other axis. FIG. 7B is a visualization interface having rotated graphical data. As shown, the data of FIG. 7A is rotated about axis 720 which was generated to be centered at selected data element 710.

FIG. 8A is a visualization interface having graphical data centered away from a coordinate origin. The interface of FIG. 8A illustrates the center 820 of the data being located on the axis 810. The data may be determined to not be within a threshold of the origin 830, such as for example the radius of the globe surrounding the data. Because the center of the data is at a point 820 on the axis 810 and not within a particular threshold of the origin 830, the center of rotation may be along axis 810, which is generated in the center 820 of the data. The center of rotation 810 may be generated as a horizontal axis, vertical axis, or other axis. FIG. 8B is a visualization interface having rotated graphical data. As shown, the data of FIG. 8A is rotated about axis 810.

FIG. 9A is a visualization interface having graphical data centered near a coordinate origin. The interface of FIG. 9A illustrates the center 920 of the data being located on the axis 910, which is also the x axis of the coordinate system. The data may be determined to be within a threshold of the origin 930, such as for example the radius of the globe surrounding the data. Because the center of the data is at a point 920 on the axis 910 and within a particular threshold of the origin 930, the center of rotation may be along axis 910, which is generated in the center 920 of the data. The center of rotation 910 may be generated as a horizontal axis, vertical axis, or other axis. FIG. 9B is a visualization interface having rotated graphical data. As shown, the data of FIG. 8A is rotated about axis 910.

Though the rotation axes in FIGS. 6A-9B are illustrated as being parallel to the x-axis, a rotation axis may have other orientations. A rotation axis may be perpendicular to a mouse drag direction, and could therefore be any line in the plane of a display—not just vertical or horizontal. When a virtual trackball is used to determine rotation, the rotation axis may be in any direction, depending on the drag direction.

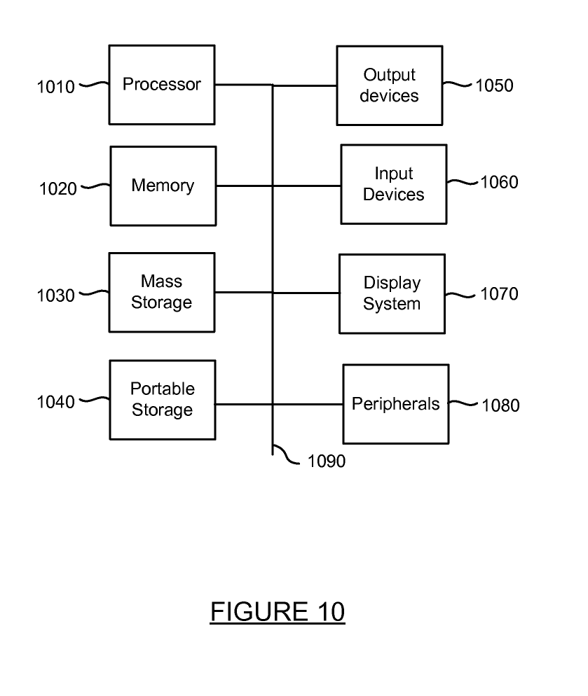

FIG. 10 provides a computing device for implementing the present technology. Computing device 1000 may be used to implement devices such as for example application servers 130, 150 and 160 and data stores 140. The computing system 1000 of FIG. 10 includes one or more processors 1010 and memory 1020. Main memory 1020 stores, in part, instructions and data for execution by processor 1010. Main memory 1020 can store the executable code when in operation. The system 1000 of FIG. 10 further includes a mass storage device 1030, portable storage medium drive(s) 1040, output devices 1050, user input devices 1060, a graphics display 1070, and peripheral devices 1080.

The components shown in FIG. 10 are depicted as being connected via a single bus 1090. However, the components may be connected through one or more data transport means. For example, processor unit 1010 and main memory 1020 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive or an optical disk drive, is a non-volatile storage device for storing data and instructions for use by processor unit 1010. Mass storage device 1030 can store the system software for implementing embodiments of the present invention for purposes of loading that software into main memory 1020.

Portable storage device 1040 operates in conjunction with a portable non-volatile storage medium, such as a floppy disk, compact disk or Digital video disc, to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, or a pointing device, such as a mouse, a track ball, stylus, or cursor direction keys. Additionally, the system 1000 as shown in FIG. 10 includes output devices 1050. Examples of suitable output devices include speakers, printers, network interfaces, and monitors.

Display system 70 may include a liquid crystal display (LCD) or other suitable display device. Display system 1070 receives textual and graphical information, and processes the information for output to the display device.

Peripherals 1080 may include any type of computer support device to add additional functionality to the computer system. For example, peripheral device(s) 1080 may include a modem or a router.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for displaying data, comprising:
providing an image of multi-dimensional data within a graphical portion of an interface;
automatically determining a center of rotation for the multi-dimensional data, wherein the center of rotation is determined based on data selected by a user;
receiving input to rotate the data about the center of rotation; and
displaying the data rotated about the automatically determined center of rotation.

2. (canceled)

3. The method of claim 1, wherein the center of rotation is determined to be the center of selected data.

4. The method of claim 1, wherein the center of rotation is based on the position of a cursor manipulated by a user within the graphical portion.

5. The method of claim 4, wherein the center of rotation is determined to be the center of a data cluster encompassing the cursor.

6. The method of claim 1, wherein the center of rotation is determined to be the center of the displayed multi-dimensional data.

7. The method of claim 1, wherein the center of rotation is determined to be the center of the display used to display the multi-dimensional data.

8. The method of claim 1, further comprising:
receiving input to select a portion of data after automatically determining the center of rotation; and
automatically determining a new center of rotation for the multi-dimensional data to be the center of the selected data before receiving input to rotate the data.

9. A non-transitory computer readable storage medium having embodied thereon a program, the program being executable by a processor to perform a method for displaying data, the method comprising:
providing an image of multi-dimensional data within a graphical portion of an interface;
automatically determining a center of rotation for the multi-dimensional data, wherein the center of rotation is determined based on data selected by a user;
receiving input to rotate the data about the center of rotation; and
displaying the data rotated about the automatically determined center of rotation.

10. (canceled)

11. The non-transitory computer readable storage medium of claim 9, wherein the center of rotation is determined to be the center of selected data.

12. The non-transitory computer readable storage medium of claim 9, wherein the center of rotation is based on the position of a cursor manipulated by a user within the graphical portion.

13. The non-transitory computer readable storage medium of claim 12, wherein the center of rotation is determined to be the center of a data cluster encompassing the cursor.

14. The non-transitory computer readable storage medium of claim 9, wherein the center of rotation is determined to be the center of the displayed multi-dimensional data.

15. The non-transitory computer readable storage medium of claim 9, wherein the center of rotation is determined to be the center of the display used to display the multi-dimensional data.

16. The non-transitory computer readable storage medium of claim 9, further comprising:
receiving input to select a portion of data after automatically determining the center of rotation; and
automatically determining a new center of rotation for the multi-dimensional data to be the center of the selected data before receiving input to rotate the data.

17. A system for displaying data, comprising:
a processor;
memory;
one or more modules stored in memory and executed by the processor to provide an image of multi-dimensional data within a graphical portion of an interface, automatically determine a center of rotation for the multi-dimensional data, wherein the center of rotation is determined based on data selected by a user, receive input to rotate the data about the center of rotation, and display the data rotated about the automatically determined center of rotation.

18. (canceled)

19. The system of claim 17, wherein the center of rotation is determined to be the center of selected data.

20. The system of claim 17, wherein the center of rotation is based on the position of a cursor manipulated by a user within the graphical portion.

21. The system of claim 20, wherein the center of rotation is determined to be the center of a data cluster encompassing the cursor.

22. The system of claim 17, wherein the center of rotation is determined to be the center of the displayed multi-dimensional data.

23. The system of claim 17, wherein the center of rotation is determined to be the center of a display used to display the multi-dimensional data.

24. The system of claim 17, the one or more modules further executable to receive input to select a portion of data after automatically determining the center of rotation and automatically determine a new center of rotation for the multi-dimensional data to be the center of the selected data before receiving input to rotate the data.
